(19) United States
(12) Patent Application Publication
(10) Pub. No.: US 2005/0265205 A1
(43) Pub. Date: Dec. 1, 2005

(54) Method for real-time adjustment of servo gain in an optical recording system according to reflected recording light beam

(75) Inventors: Yao-Lung Chuang, Taipei Hsien (TW); Hsin-Chung Yeh, Taipei Hsien (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: MEDIATEK INC

(21) Appl. No.: 10/955,343

(22) Filed: Sep. 29, 2004

(30) Foreign Application Priority Data
May 27, 2004 (TW) 093115109

(51) Int. Cl. G11B 7/00

(52) U.S. Cl. 369/116; 369/47.5; 369/44.29; 369/59.1

(57) ABSTRACT

An optical recording system includes an optical pickup, a power auto-control device, and a digital signal processor. The optical pickup includes a laser diode and a photo detector. The power auto-control device generates a drive voltage for driving the laser diode to generate a recording light beam incident upon an optical storage medium. The photo detector is operable to generate a sub-beam added signal from light that was reflected by the optical storage medium and that was detected by the photo detector during recording using the recording light beam. The digital signal processor compares the sub-beam added signal from the photo detector with a predetermined target value, and enables the power auto-control device to adjust the drive voltage in such a manner that the sub-beam added signal approaches the predetermined target value based on result of the comparison made by the digital signal processor.

### CROSS-REFERENCE TO RELATED APPLICATION

This application claims priority of Taiwanese application no. 093115109, filed on May 27, 2004.

### BACKGROUND OF THE INVENTION

1. Field of the Invention

The invention relates to a method for adjustment of servo gain in an optical recording system, more particularly to a method for real-time adjustment of servo gain in an optical recording system according to reflected recording light beam.

2. Description of the Related Art

Referring to FIG. 1, a conventional optical recording system 1 is shown to include an optical pickup 2, a power auto-control device 3, a digital signal processor (DSP) 4, and an object lens servo loop 5.

The optical pickup 2 includes a laser diode 21, a beam power detector 22, and a photo detector 23.

The power auto-control device 3 is used to generate a drive voltage for driving the laser diode 21, and includes a first beam power controller 31 and a second beam power controller 32. In a recording mode, based on digital data to be recorded, the first beam power controller 31 and the second beam power controller 32 are operable so as to generate a higher first drive voltage and a lower second drive voltage respectively for driving the laser diode 21 to generate a corresponding first light beam or a corresponding second light beam in order to form a pit region or a land region on an optical storage medium for data storage. While the recording light beam can be the first or second light beam, the second light beam is also used as a reading light beam in a playback mode of the optical recording system 1.

The first beam power controller 31 includes a first sample-and-hold circuit 311 coupled to the beam power detector 22, and a first voltage generator 312 coupled to the first sample-and-hold circuit 311, the laser diode 21 and the DSP 4. The second beam power controller 32 likewise includes a second sample-and-hold circuit 321 coupled to the beam power detector 22, and a second voltage generator 322 coupled to the second sample-and-hold circuit 321, the laser diode 21 and the DSP 4. In order to stabilize output beam power of the laser diode 21 during a recording process, the beam power detector 22 generates a feedback signal (Vf) indicative of power of the light beam generated by the laser diode 21. As best shown in FIG. 2A, when the laser diode 21 outputs the first light beam, the feedback signal (Vf) has a low logic state (for instance, +1.5 volts), and when the laser diode 21 outputs the second light beam, the feedback signal (Vf) has a high logic state (for instance, +2.4 volts). The higher the beam power of the first light beam, the lower will be the level value of the feedback signal (Vf). On the other hand, the lower the beam power of the second light beam, the higher will be the level value of the feedback signal (Vf).

The feedback signal (Vf) is provided to the first and second sample-and-hold circuits 311, 321 of the first and second beam power controllers 31, 32. Each of the first and second sample-and-hold circuits 311, 321 samples low or high logic portions (L1, L2) of the feedback signal (Vf) according to a respective sampling clock (CLK1, CLK2), as best shown in FIGS. 2A to 2C. Each of the first and second sample-and-hold circuits 311, 321 then provides a sample value (VS1, VS2) to the corresponding one of the first and second voltage generators 312, 322. Each of the first and second voltage generators 312, 322 generates a respective one of the first and second drive voltages (Vd1, Vd2) with reference to the sample value (VS1, VS2) received from the corresponding one of the first and second sample-and-hold circuits 311, 321 and a corresponding one of a first reference signal (Vref1) (for instance, +3 volts) and a second reference signal (Vref2) (for instance, +1 volt) from the DSP 4. In this way, the output beam power of the laser diode 21 can be compensated and stabilized.

During the recording process, the photo detector 23 of the optical pickup 2 is operable to generate a sub-beam added (SBAD) signal from light that was reflected by the optical storage medium. Since the SBAD signal is proportional to the beam power outputted by the laser diode 21, the photo detector 23 has a saturated output when the laser diode 21 generates the high-power first light beam. As such, with reference to FIGS. 3A to 3C and FIGS. 4A to 4C, it is the SBAD signal associated with the low-power second light beam that is used for generating a focusing error (FE) signal and a track-locking error (TE) signal suitable for object lens focusing and track-locking servo control. That is, the beam power (or the SBAD signal) of the second light beam is proportional to the FE signal and the TE signal. Since the FE signal and the TE signal are proportional to the loop gain of the object lens servo loop 5, the magnitude of the SBAD signal associated with the second light beam affects the loop gain of the object lens servo loop 5, and hence the stability of the object lens servo loop 5. Referring to FIGS. 5A to 5C, in the recording mode, when the recording speed of the optical recording system 1 gradually increases to a certain value (such as 52× and above), the step response speed of the feedback signal (Vf′) is normally unable to keep up with variations in the beam power of the recording light beam, thereby resulting in edge delay phenomenon. At the same time, overshooting or undershooting of the feedback signal (Vf′) arises in undesired drift in the sample values (VS1, VS2) of the first and second sample-and-hold circuits 311, 321, which sample the feedback signal (Vf′) using the corresponding one of the sampling clocks (CLK1, CLK2). As a result, a transition point (P1) (for instance, +1.7 volts, which is higher than the normal value of +1.5 volts) that is positioned midway in a falling edge from a high logic state (+2.4 volts) to a low logic state (+1.5 volts) of the feedback signal (Vf′) might be sampled using the sampling clock (CLK1), whereas a transition point (P2) (for instance +2.2 volts, which is lower than the normal value of +2.4 volts) that is positioned midway in a rising edge from a low logic state (+1.5 volts) to a high logic state (+2.4 volts) of the feedback signal (Vf′) might be sampled using the sampling clock (CLK2). Therefore, the first voltage generator 312 might make a misjudgment that the beam power of the first light beam is insufficient, and undesirably responds by raising the level of the first drive voltage (Vd1), which causes the first light beam to have an incorrect higher value. In addition, the second voltage generator 322 might also make a misjudgment that the beam power of the second light beam is too high, and undesirably responds by reducing the level of the second drive voltage (Vd2), which causes that the second light beam to have an incorrect lower value. If these phenomena persist for some time, the beam powers of the first and second light beams outputted by the laser diode 21 will drift from their respective target values. Referring once again to FIGS. 3A to 3C and to FIGS. 4A to 4C, it is evident that undesired changes in the beam power of the second light beam will affect generation of the SBAD signal, the TE signal and the FE signal, thereby undesirably altering the loop gain of the object lens servo loop 5. Unstable operation of the object lens servo loop 5 results when the loop gain varies beyond a predetermined range, which can lead to failure of the recording operation due to improper object lens focusing and improper track-locking control.

In sum, if feedback control of the power auto-control device 3 becomes unreliable during the data recording process, the beam power outputted by the laser diode 21 will gradually drift from a normal value and, as a consequence, alters undesirably the loop gain of the object lens servo loop 5 such that the object lens servo loop 5 of the optical recording system 1 becomes unstable.

### SUMMARY OF THE INVENTION

Therefore, the object of the present invention is to provide a method for real-time adjustment of servo gain in an optical recording system so as to overcome the aforesaid drawback associated with the prior art.

According to one aspect of the present invention, there is provided a method for real-time adjustment of servo gain in an optical recording system that includes an optical pickup and a power auto-control device that is operable so as to generate a drive voltage for driving the optical pickup to generate a recording light beam which is used to record data on an optical storage medium. The method comprises the steps of:
a) generating a sub-beam added signal from light that was reflected by the optical storage medium during recording on the optical storage medium using the recording light beam;
b) comparing the sub-beam added signal generated in step a) with a predetermined target value; and
c) based on result of the comparison made in step b), enabling the power auto-control device to adjust the drive voltage in such a manner that the sub-beam added signal approaches the predetermined target value.

According to another aspect of the present invention, there is provided an optical recording system that comprises an optical pickup, a power auto-control device, and a digital signal processor.

The optical pickup includes a laser diode and a photo detector.

The power auto-control device is coupled to the optical pickup, and is operable so as to generate a drive voltage for driving the laser diode to generate a recording light beam that is used to record data on an optical storage medium.

The photo detector is operable so as to generate a sub-beam added signal from light that was reflected by the optical storage medium during recording on the optical storage medium using the recording light beam and that was detected by the photo detector.

The digital signal processor is coupled to the power auto-control device, receives the sub-beam added signal, compares the sub-beam added signal with a predetermined target value, and enables the power auto-control device to adjust the drive voltage in such a manner that the sub-beam added signal approaches the predetermined target value based on result of the comparison made by the digital signal processor.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a conventional optical recording system;

FIGS. 2A to 2C illustrate a feedback signal (Vf) a second sampling clock (CLK2) and a first sampling clock (CLK1) generated during a low-speed recording operation of the conventional optical recording system;

FIGS. 3A to 3C illustrate how FE and SBAD signals are related to beam power in the conventional optical recording system of FIG. 1;

FIGS. 4A to 4C illustrate how TE and SBAD signals are related to beam power in the conventional optical recording system of FIG. 1;

FIGS. 5A to 5C illustrate a feedback signal (Vf) a second sampling clock signal (CLK2) and a first sampling clock signal (CLK1) generated during a high-speed recording operation of the conventional optical recording system;

FIG. 6 is a schematic block diagram of the preferred embodiment of an optical recording system according to the present invention;

FIG. 7 is a flowchart to illustrate how servo gain is adjusted in the optical recording system of the preferred embodiment; and

FIG. 8 is a schematic diagram to illustrate how an SBAD signal is generated in the system of the preferred embodiment.

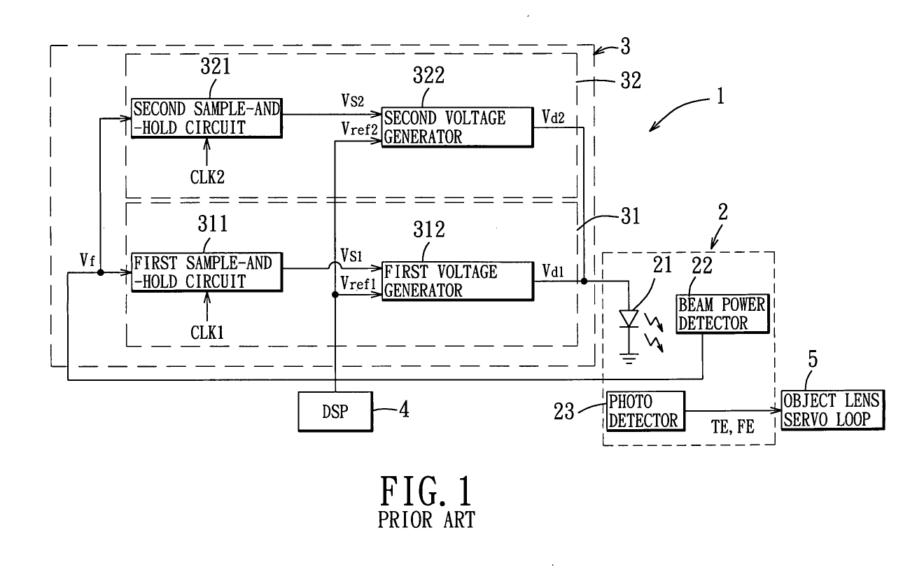

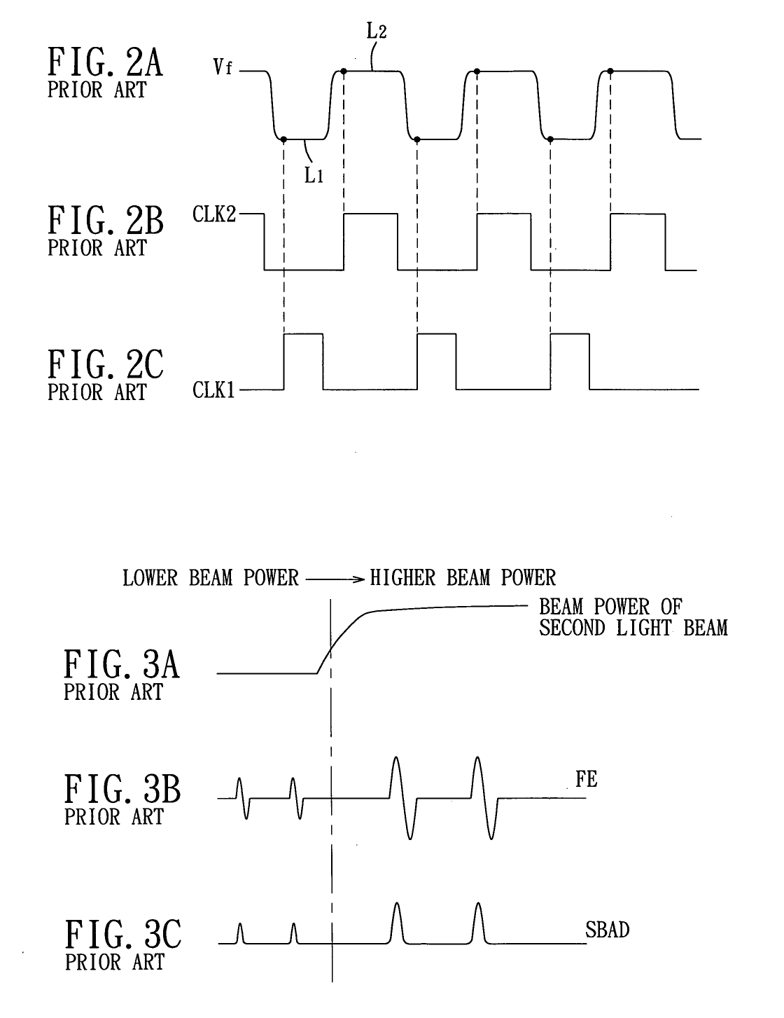

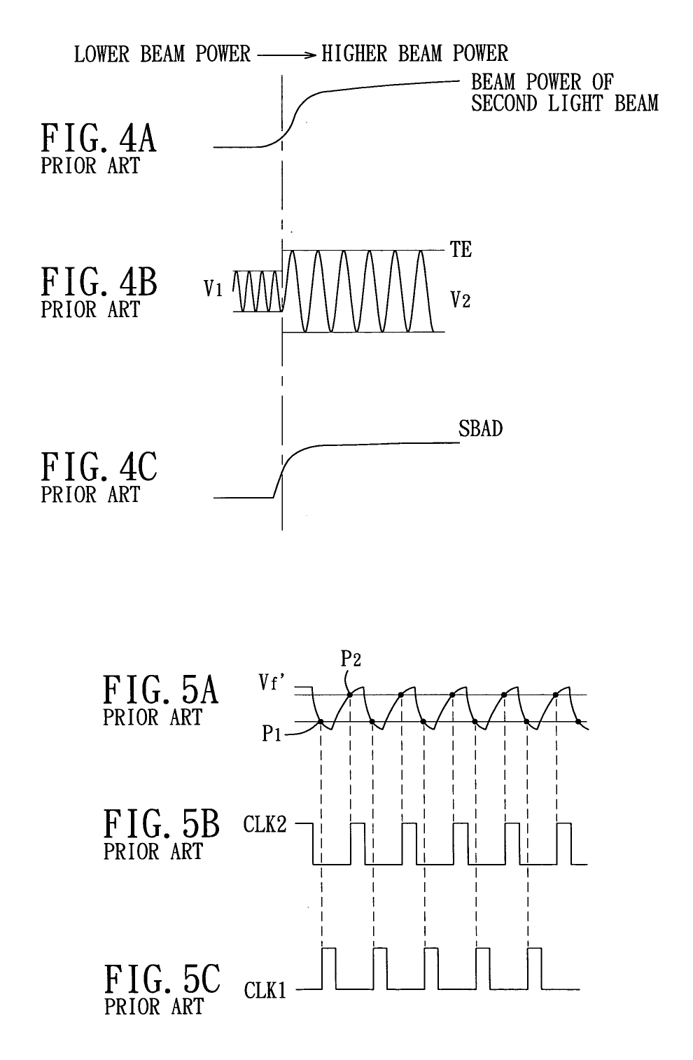

### DETAILED DESCRIPTION OF THE PREFERRED EMBODIMENT

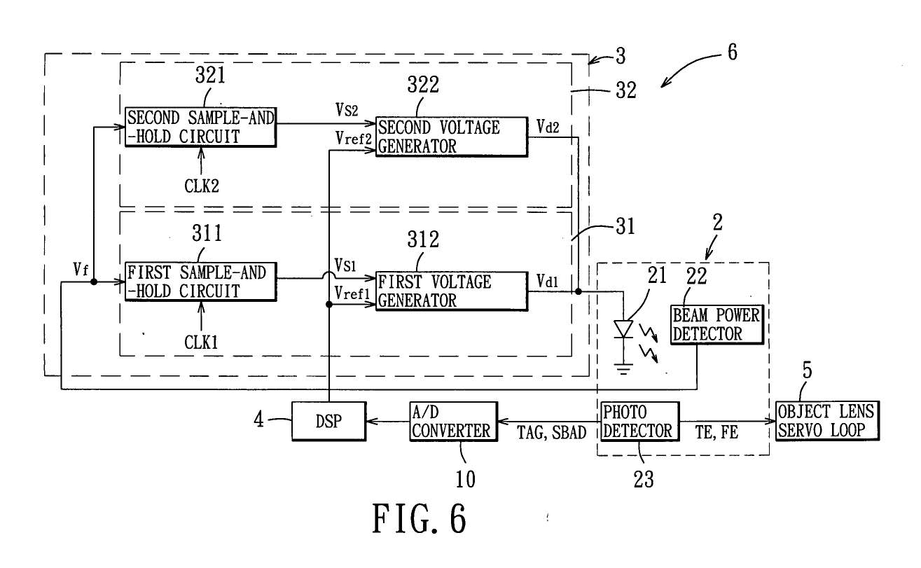

FIG. 6 illustrates the preferred embodiment of an optical recording system 6 that is capable of real-time adjustment of servo gain according to the present invention for overcoming the aforesaid drawback of unstable operation of the object lens servo loop 5 due to unreliable feedback signals (Vf) that are generated during a high-speed recording operation of the conventional optical recording system 1. The optical recording system 6 is adapted to be loaded with an optical storage medium 7 (see FIG. 8), and is shown to include components identical to those of the conventional optical recording system 1 described beforehand, except for an additional analog-to-digital (A/D) converter 10 coupled between the DSP 4 and the photo detector 23 of the optical pickup 2.

Moreover, in the present invention, the DSP 4 comprises program instructions for configuring the DSP 4 to perform a method for real-time servo gain adjustment, the method including:

Stage (A): Obtaining a predetermined target (TAG) value used for reference:

Before an actual recording operation, the optical recording system 6 performs a calibration procedure while operated in the playback mode for focusing and track-locking control. During the calibration procedure, the power auto-control device 3 drives the laser diode 21 of the optical pickup 2 to generate the low-power second light beam as a reading light beam, the SBAD signal generated by the photo detector 23 has a normal value, and the TE and FE signals are at their respective normal values as well. In the meantime, since the feedback signal (Vf) generated through detection of the beam power by the beam power detector 22 is a direct current (DC) value, there is no frequency response problem during the calibration procedure.

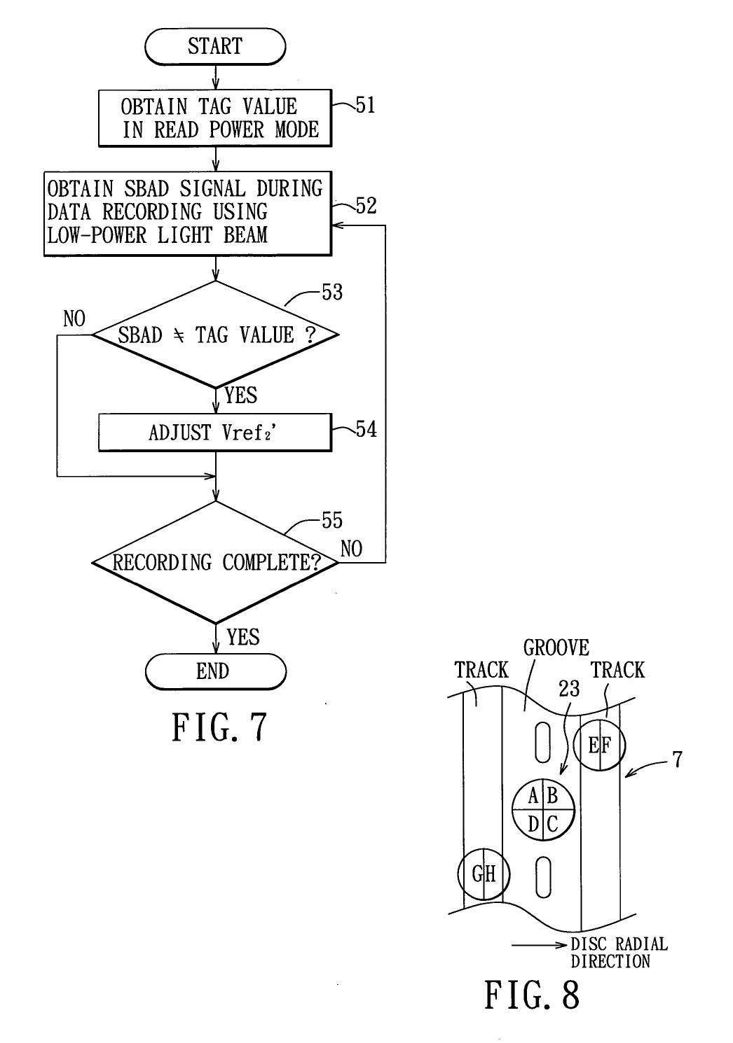

Hence, referring to FIG. 7, in step 51, the photo detector 23 operates during the calibration procedure to generate the SBAD signal associated with the second light beam. As shown in FIG. 8, the photo detector 23 includes four primary light beam detecting components (A), (B), (C), (D), and four secondary light beam detecting components (E), (F), (G), (H) that are disposed to detect reflected light from the optical storage medium 7. In this embodiment, the TAG value is a sum of the reflected light components detected by the secondary light beam detecting components (E), (F), (G), (H) and digitized by the A/D converter 10 for subsequent storage in the DSP 4. However, in other embodiments of this invention, the TAG value may as well be a sum of the reflected light components detected by the primary light beam detecting components (A), (B), (C), (D), a sum of the reflected light components detected by the primary and secondary light beam detecting components (A), (B), (C), (D), (E), (F), (G), (H), or other combinations of the light beam detecting components.

Stage (B): Obtaining the SBAD signal during data recording using the low-power second light beam.

In step 52, the photo detector 23 generates the SBAD signal (such as by summing the reflected light components detected by the secondary light beam detecting components (E), (F), (G), (H) or by other combinations of the light beam detecting components) associated with the second light beam during the actual recording operation of the optical recording system 6. The SBAD signal thus generated is digitized by the A/D converter 10 and provided to the DSP 4.

Stage (C) : Adjust beam power of the second light beam.

In step 53, the DSP 4 compares the SBAD signal with the TAG value. If the SBAD signal is not within the vicinity of the TAG value, which indicates that the sample value (VS2) from the second sample-and-hold circuit 321 of the second beam power controller 32 is incorrect, since the sample value (VS2) is used for reference in the generation of the second drive voltage (Vd2) by the second voltage generator 322, the beam power of the second light beam generated by the laser diode 21 will be undesirably lower in the prior art as a result.

To avoid the aforesaid drawback, in step 54, the DSP 4 adjusts the second reference voltage (Vref2′) that is provided to the second voltage generator 322 based on the result of the comparison made by the DSP 4, thereby enabling the second voltage generator 322 to adjust the second drive voltage (Vd2) to compensate for sampling error at the second sample-and-hold circuit 321 in such a manner that the SBAD signal approaches the TAG value.

Then, in step 55, the aforesaid steps 52 to 54 are repeated until the data recording process is completed.

In this manner, the TE signal and the FE signal can be maintained at normal values through fixing of the SBAD signal such that the loop gain of the object lens servo loop 5 can be maintained within a predetermined range, thereby stabilizing control of focusing of the object lens as well as track-locking throughout the data recording process.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for real-time adjustment of servo gain in an optical recording system, the optical recording system including an optical pickup and a power auto-control device that is operable so as to generate a drive voltage for driving the optical pickup to generate a recording light beam, the recording light beam being used to record data on an optical storage medium, said method comprising the steps of:
a) generating a sub-beam added signal from light that was reflected by the optical storage medium during recording on the optical storage medium using the recording light beam;
b) comparing the sub-beam added signal generated in step a) with a predetermined target value; and
c) based on result of the comparison made in step b), enabling the power auto-control device to adjust the drive voltage in such a manner that the sub-beam added signal approaches the predetermined target value.

2. The method as claimed in claim 1, wherein step a) is performed while the optical recording system is operated in a recording mode,
the optical pickup being operable to generate one of a first light beam having a higher beam power for forming a pit region on the optical storage medium, and a second light beam having a lower beam power for forming a land region on the optical storage medium,
the sub-beam added signal being generated during recording on the optical storage medium using the second light beam.

3. The method as claimed in claim 2, wherein the optical pickup is operable to generate the second light beam as a reading light beam when the optical recording system is operated in a playback mode,
the predetermined target value used for reference in step b) being obtained when the optical recording system performs a calibration procedure while the optical recording system is operated in the playback mode.

4. The method as claimed in claim 1, the power auto-control device being operable so as to generate one of a higher drive voltage for driving the optical pickup to generate a first light beam, and a lower drive voltage for driving the optical pickup to generate a second light beam, wherein, in step c), the power auto-control device is enabled to adjust the lower drive voltage based on the result of the comparison made in step b).

5. An optical recording system comprising:
an optical pickup including a laser diode and a photo detector;
a power auto-control device coupled to said optical pickup and operable so as to generate a drive voltage for driving said laser diode to generate a recording light beam, the recording light beam being used to record data on an optical storage medium;
said photo detector being operable so as to generate a sub-beam added signal from light that was reflected by the optical storage medium during recording on the optical storage medium using the recording light beam and that was detected by said photo detector; and a digital signal processor coupled to said power auto-control device, receiving the sub-beam added signal, comparing the sub-beam added signal with a predetermined target value, and enabling said power auto-control device to adjust the drive voltage in such a manner that the sub-beam added signal approaches the predetermined target value based on result of the comparison made by said digital signal processor.

6. The optical recording system as claimed in claim 5, wherein said optical pickup is operable so as to generate one of a first light beam having a higher beam power for forming a pit region on the optical storage medium, and a second light beam having a lower beam power for forming a land region on the optical storage medium,
the sub-beam added signal being generated by said photo detector during recording on the optical storage medium using the second light beam.

7. The optical recording system as claimed in claim 6, wherein said optical pickup is further operable so as to generate the second light beam as a reading light beam when reading data from the optical storage medium,
the predetermined target value used for reference by said digital signal processor being obtained from said photo detector when the optical recording system performs a calibration procedure while the optical recording system is operated in a playback mode.

8. The optical recording system as claimed in claim 5, wherein said power auto-control device is operable so as to generate one of a higher drive voltage for driving said laser diode to generate a high-power light beam in order to form a pit region on the optical storage medium, and a lower drive voltage for driving said laser diode to generate a low-power light beam in order to form a land region on the optical storage medium,
said power auto-control device including first and second beam power controllers for generating the higher and lower drive voltages, respectively,
said digital signal processor enabling said second beam power controller to adjust the lower drive voltage based on the result of the comparison made by said digital signal processor.

9. The optical recording system as claimed in claim 8, wherein said optical pickup is further operable so as to generate the low-power light beam as a reading light beam when reading data from the optical storage medium,
the predetermined target value used for reference by said digital signal processor being obtained from said photo detector when the optical recording system performs a calibration procedure while the optical recording system is operated in a playback mode.

10. The optical recording system as claimed in claim 9, wherein said optical pickup further includes a beam power detector for generating a feedback signal indicative of power of the light beam generated by said laser diode, the feedback signal having a first logic state when said laser diode generates the high-power light beam, and a second logic state when said laser diode generates the low-power light beam.

11. The optical recording system as claimed in claim 10, wherein the first logic state is a low logic state, and the second logic state is a high logic state.

12. The optical recording system as claimed in claim 10, wherein:
said first beam power controller includes a first sample-and-hold circuit coupled to said beam power detector, and a first voltage generator coupled to said first sample-and-hold circuit, said laser diode and said digital signal processor, said first voltage generator generating the higher drive voltage with reference to the first logic state of the feedback signal and a first reference signal from said digital signal processor; and
said second beam power controller includes a second sample-and-hold circuit coupled to said beam power detector, and a second voltage generator coupled to said second sample-and-hold circuit, said laser diode and said digital signal processor, said second voltage generator generating the lower drive voltage with reference to the second logic state of the feedback signal and a second reference signal from said digital signal processor.

13. The optical recording system as claimed in claim 12, wherein said digital signal processor enables said second beam power controller to adjust the lower drive voltage by varying the second reference signal based on the result of the comparison made by said digital signal processor.

14. A digital signal processor for an optical recording system, the optical recording system including
an optical pickup including a laser diode and a photo detector, and
a power auto-control device coupled to the optical pickup and operable so as to generate a drive voltage for driving the laser diode to generate a recording light beam, the recording light beam being used to record data on an optical storage medium,
the photo detector being operable so as to generate a sub-beam added signal from light that was reflected by the optical storage medium during recording on the optical storage medium using the recording light beam and that was detected by the photo detector,
said digital signal processor being adapted to be coupled to the power auto-control device and to receive the sub-beam added signal, and comprising program instructions for configuring said digital signal processor to perform a method for real-time servo gain adjustment, the method including:
i) comparing the sub-beam added signal with a predetermined target value; and
ii) enabling the power auto-control device to adjust the drive voltage in such a manner that the sub-beam added signal approaches the predetermined target value based on result of the comparison made in step i).
